(19) United States
(12) Patent Application Publication
(10) Pub. No.: US 2010/0254117 A1
(43) Pub. Date: Oct. 7, 2010

(54) Light emitting device having LED and flexible electrical wiring covered and plastic material

(76) Inventors: Chih-Hua Hsu, Savannah, GA (US); Jung-Shiung Liau, Savannah, GA (US)

Correspondence Address: BACON & THOMAS, PLLC, 625 SLATERS LANE, FOURTH FLOOR, ALEXANDRIA, VA, 22314-1176, US

(21) Appl. No.: 12/385,930

(22) Filed: Apr. 24, 2009

(30) Foreign Application Priority Data
Apr. 7, 2009 (TW) 098111526

(51) Int. Cl. G02F 1/13357; F21S 4/00

(52) U.S. Cl. 362/97.1; 362/249.02

(57) ABSTRACT

A light emitting device comprises an LED and flexible electrical wiring covered with plastic material, wherein the plastic material as a coater is coated and flatted on the flexible electrical wiring. The coater is partially truncated on truncated portions so that one side or both sides of the flexible electrical wiring is/are exposed so as to couple the LED to supply power for the LED.

### BACKGROUND

The present invention relates to a light emitting device, more particularly, to a light emitting device having LED and flexible electrical wiring covered with plastic material.

Since the light emitting diode (referred to as “LED” hereinafter) has developed in 1950's, it is commonly used in many fields. LEDs convert electrical energy into light energy. Firstly, the fifth group elements (such as nitrogen (N), phosphorous (P), and arsenic (As)) and the third group elements (such as aluminum (Al), gallium (Ga), and indium (In)) suffer the process of liquid phase epitaxy (referred to as “LPE” hereinafter) or vapor phase epitaxy (referred to as “VPE” hereinafter) to produce III-V compound semiconductor (such as gallium phosphide (GaP) or gallium arsenide (GaAs)) to form a substrate. Then it applies voltage between a positive electrode and a negative electrode of the substrate. Thus an electrical current passes through the substrate to make electron and hole combine each other. The electrons therefore fall into the region with low valance and release the excess energy in a form of light. The LEDs emit light thereby.

The LEDs use low voltage power instead of high voltage power so the power consumption is 80% less than the incandescent lamps having the same luminous efficiency as the LEDs. Each LED is a square or a circular piece with the size of 3 to 5 mm. Thus the LEDs are allowed to be manufactured as any element in desire. The light strength decays to 50% of original light strength after 100000 hours. The response time of the LEDs is more than 1000 times faster than that of the incandescent lamps. There is no detrimental metal (such as mercury) in the LEDs so that the environment contamination is reduced. Light with various colors may be emitted by changing the chemical material in the substrate. The LEDs can emit light without tungsten filaments so the heat dissipated by the LEDs is less. The LEDs can be touched directly by hands due to the low temperature itself. The LEDs are safer than other lamps. The LEDs are classified into various types such as visible light LEDs (if the wave length is between 450 and 680 nm) and invisible light LEDs (referred to as short wave length infrared light if the wave length is between 850 and 950 nm, and referred to as long wave length infrared light if the wave length is between 1300 and 1550 nm) according to the wave length. The LEDs can be used for indicating light sources of information appliances, interior displays, large billboards, traffic signs, back lights of portable electrical devices (such as cell phones and personal digital assistants (PDAs)), interior lighting, exterior lamps of vehicles, infrared communication of vehicles, IrDA modules, integrated transmission of information appliances, remote controllers, communicating light sources in short distance, backlights of LCDs, and projectors.

The brightness and utilization of LEDs can be enhanced if the LEDs are concatenated. Conventional, a plurality of LEDs are placed and covered by a flexible printed circuit (referred to as “FPC” hereinafter) in consideration of concatenation of LEDs. The substrate made of polyimide (referred to as “PI” hereinafter) or polyethylene terephthalate (referred to as “PET” hereinafter) is covered with copper foil, and the copper foil is etched and the LEDs or electrical elements such as resistors or capacitors are installed thereon. In spite that the wirings of the LEDs concatenated by FPC are thus flexible however, the flexibility is not the best. Moreover, the cost is very high due to the necessity of etching on the copper foil of FPC. In addition, the back surface of the LEDs is soldered on the copper foil such that the back surface can not in contact with air. Therefore, the heat dissipation of the LEDs is very poor.

A flexible flat cable (referred to as “FFC” hereinafter) which is mainly used as flexible connecting wirings in computer is flexible electrical wirings covered with plastic material. The thin tinned copper lines are covered with insulating material such as PET, polyvinylchloride (referred to as “PVC” hereinafter), PI, or polyester film as a coater. The copper lines and the coater are flatted by a high-tech automatic apparatus. With the LEDs concatenated by FFC instead of FPC, there are advantages in less cost, better flexibility, better heat dissipation, and better electromagnetic interference (referred to as “EMI” hereinafter) solution. Additionally, EMI solution is improved by providing copper foil or aluminum foil on the covering surface of FFCs.

### BRIEF SUMMARY

In consideration of LED concatenation, the light emitting device having LED and flexible electrical wiring covered with plastic material of the present invention is advantageous in less cost, better flexibility, better heat dissipation, and better EMI solution.

The light emitting device of the present invention comprises an LED; and flexible electrical wirings covered with plastic material, wherein the plastic material as a coater is coated and flatted on the flexible electrical wiring, and the coater is partially truncated as truncated portions so that one side or both sides of the flexible electrical wirings are exposed so as to couple the LED to supply power for the LED. A plurality of LEDs may be connected in serial, in parallel or any combination thereof, and/or the flexible electrical wiring may be connected in any concatenate manner including serial or parallel or any combination thereof or side by side or any combination thereof.

In other aspect of the light emitting device of the present invention, the truncated portions may be any shape that can expose the flexible electrical wiring, and the portion of the LED that is not in contact with the electrical wirings are exposed to the air.

In other aspect of the light emitting device of the present invention, the coater is polyethylene terephthalate, polyester film, polyvinylchloride or polyimide, and the flexible electrical wiring is a copper line. The copper line may be surface treated.

In other aspect of the light emitting device of the present invention, the number and the pitch of the exposed flexible electrical wiring may be varied according to the number and the pins of the corresponding LED.

In other aspect of the light emitting device of the present invention, one or more LEDs are provided on the one or both exposed sides of the flexible electrical wiring, or two opposite LEDs are provided on both sides of a single area of the flexible electrical wiring. The LEDs may be connected in serial, in parallel or any combination thereof, and/or the flexible electrical wiring may be connected in any concatenation manner including serial or parallel or any combination thereof or side by side or any combination thereof.

In other aspect of the light emitting device of the present invention, a circular ferrite core is provided on the surface of the coater, and/or the surface of the coater is covered with special material such as conductive silver paste, conductive fabric, acetic fabric, mylar, copper foil or aluminum foil.

In other aspect of the light emitting device of the present invention, an adhesive layer may be provided on the surface of the coater to adhere the light emitting device to any material or other products.

The light emitting device having an LED and flexible electrical wirings covered with plastic material of the present invention has advantages in less cost, better flexibility, better heat dissipation, and better EMI solution by connecting LEDs using a flexible electrical wiring covered with plastic material.

### BRIEF DESCRIPTION OF THE DRAWINGS

FIG. 1 is a top view of the light emitting device having LEDs and flexible electrical wirings covered with plastic material according to the present invention.

FIG. 2 is a 3D view of the light emitting device having LEDs and flexible electrical wirings covered with plastic material according to the present invention.

FIG. 3 is a back 3D view of the light emitting device according to the present invention.

FIG. 4 is a partial side view of light emitting device 1 having LEDs and flexible electrical wirings covered with plastic material according to one embodiment of the present invention.

FIG. 5 is a partial side view of light emitting device 1 having LEDs and flexible electrical wirings covered with plastic material according to another embodiment of the present invention.

FIG. 6 is a 3D view of light emitting device 1 having LEDs and flexible electrical wirings covered with plastic material according to another embodiment of the present invention.

FIG. 7 is a side view of the heat dissipating method of the light emitting device 1 having LEDs and flexible electrical wirings covered with plastic material according to another embodiment of the present invention.

FIG. 8 is a perspective view of a conventional flexible electrical wiring covered with plastic material.

FIG. 9 is a top view of connecting 3 light emitting devices 1 of the present invention side by side.

### DETAILED DESCRIPTION

The description below is used to describe the specific embodiments of the present invention but not to limit the way that the present invention may practice. There may be modifications, appendages, and excisions made to each element of the implementation without departing the scope of the present invention. All such modifications, appendages, and excisions are included in the scope of the present invention.

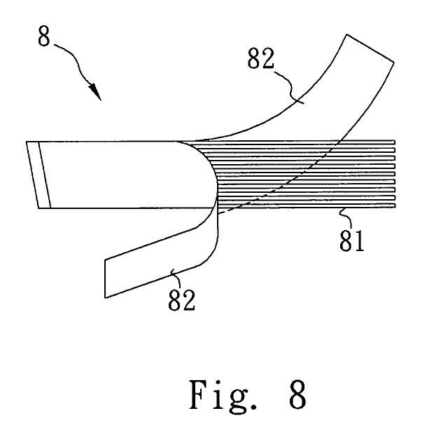

As shown in FIG. 8, it is a perspective view of a conventional FFC (with the reference number 8) covered with plastic material. It is known from FIG. 8 that FFC 8 includes a plurality of electrical wirings 81 (such as copper lines) having a flat sectional shape. The copper lines 81 are surface treated (such as tinned) and covered with plastic material made of polyethylene terephthalate, polyvinyl chloride, polyester film or polyimide as a coater 82. The copper lines 81 and the coater 82 are flatted to be FFC 8. The sectional shape of the copper lines may be a circle, an ellipse, a square, a rectangle or any other shape. The coater 82 may be thermo plastic material or thermosetting plastic material. In addition, the electrical wirings may be other electrical wirings other than the copper lines 81.

In the following description, FFC is used as an example of the flexible electrical wirings covered with plastic material.

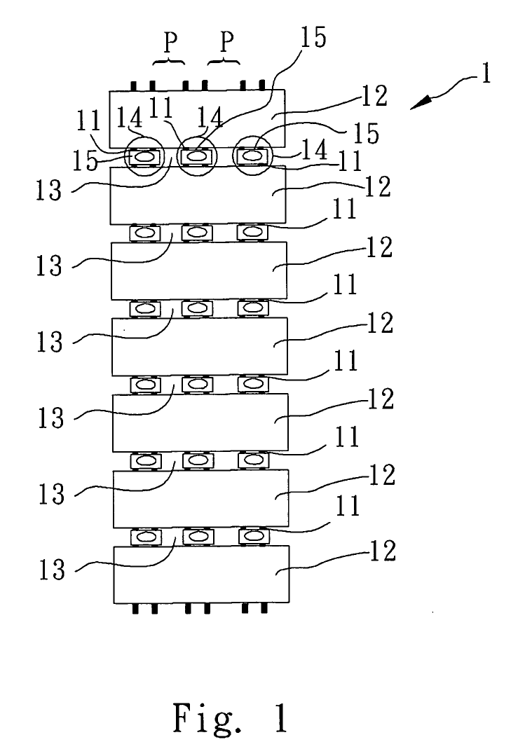

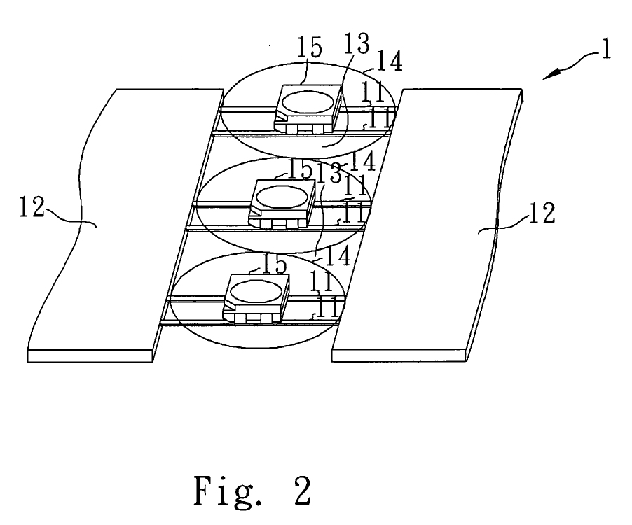

As shown in FIG. 1, it is a top view of the light emitting device 1 having LEDs and flexible electrical wirings covered with plastic material. In FIG. 1, the number of the electrical wirings 11 corresponds to the number of the LEDs. The plastic coater 12 is partially truncated to form the truncated portions 13. Thus some parts of the electrical wirings 11 (such as copper lines) are exposed to the air. The number and the pitch p of the electrical wirings 11 may be varied according to requirements. For example, when there are three LEDs, that each LED is with 2 pins, are provided in one row, the number of the electrical wirings 11 is six. Every two electrical wirings 11 form an electrical wiring combination 14 for supplying power, such as positive voltages and grounds or positive and negative voltages, for the LEDs. In other implementations, the number of the electrical wirings 11 that form an electrical wiring combination 14 may be varied according to the types of the LEDs. The number of the electrical wirings 11 that form an electrical wiring combination 14 may be six or eight for example. As shown in FIG. 1, the LEDs 15 are coupled to the exposed electrical wiring combinations 14 respectively. FIG. 2 is a 3 dimensional view of FIG. 1. FIG. 2 represents that there are three LEDs 15 coupled to the corresponding electrical wiring combinations 14 respectively. The LEDs 15 may be connected in parallel on the electrical wirings 11. If one or more LEDs 15 are out of order, the current still passes through the LEDs 15 that are still functional. The luminous efficiency of the still functional LEDs 15 is not affected. On the other hand, LEDs 15 may be connected in serial on the electrical wirings 11. The flexible electrical wirings 11 are connected in any concatenation manner including serial or parallel or any combination thereof or side by side or any combination thereof.

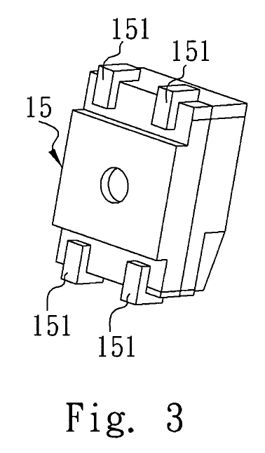

FIG. 3 illustrates contact portions 151 on the bottom of the LED 15 used for contacting the electrical wirings 11. The LEDs 15 of the present invention have better heat dissipation because only the contact portions 151 are contacted with the electrical wirings 11 and the other portions of the LEDs 15 are exposed to the air. The LED illustrated in FIG. 3 has four contact portions 151. However, the number and the position of the contact portions 151 may be different according to the types of the LEDs in practice. As the number and the position of the contact portions 151 change, the number and the position of the electrical wirings 11 may be changed.

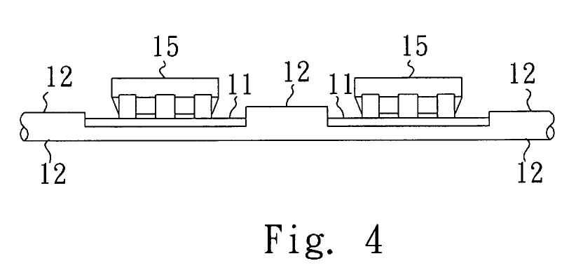

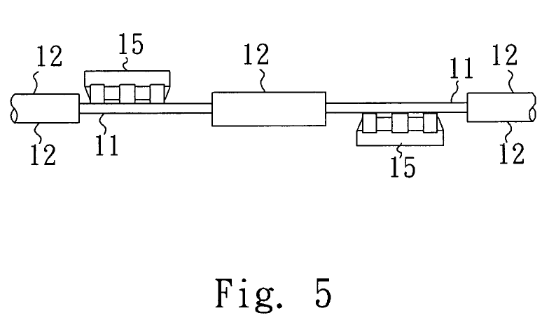

The truncated portions 13 are truncated on both sides of the coater 12, as shown in FIG. 1 and FIG. 2. Besides, the coater 12 may be truncated on a single side of the coater 12, and the LED is provided on the electrical wirings 11 on the truncated side, as shown in FIG. 4. In other words, any part of a single or both sides of the coater 12 of the FFC may be truncated to expose the electrical wirings 11 to the air. One or more LEDs 15 are provided on the exposed electrical wirings 11. The LEDs 15 may be provided oppositely on a single area of both sides of the electrical wiring. FIG. 5 illustrates that when the electrical wirings 11 are exposed on both sides, the LEDs 15 may be provided on a top side or a bottom side of different exposed surfaces.

The truncated portions 13 may be any shape to expose the electrical wirings to couple the LEDs 15.

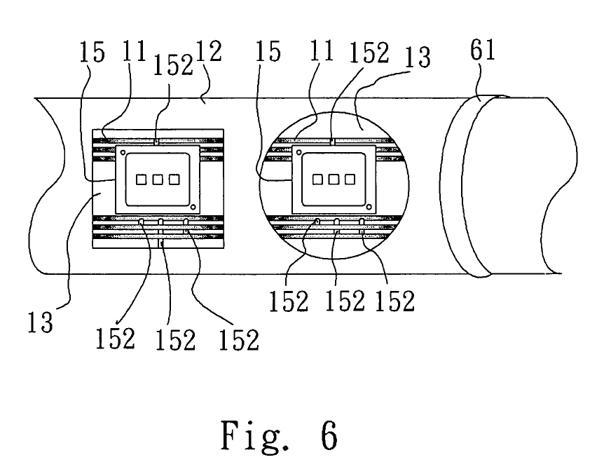

As shown in FIG. 6, a circular ferrite core 61 is provided on the surface of the coater 12. The electromagnetic interference may be improved by providing the circular ferrite core 61 around the coater 12 and/or cover the surface of the coater 12 with special material, such as conductive silver paste, conductive fabric, acetic fabric, mylar, copper foil or aluminum foil.

As shown in FIG. 6, the shape of the truncated portions 13 may be a circle, an ellipse, a rectangle, a square or any other shape to expose the electrical wirings 11 to couple the LEDs 15. In FIG. 6, the LEDs 15 are coupled to the electrical wirings 11 by a plurality of pins 152.

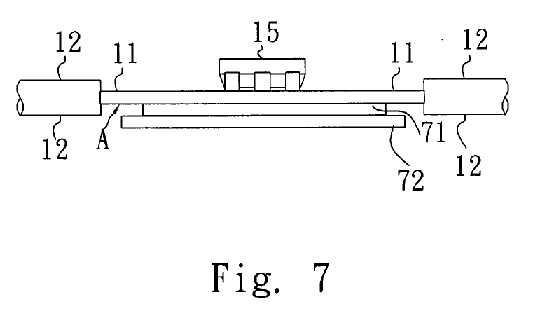

As shown in FIG. 7, the exposed surface A on the opposite side of the LED 15 may be hollow and contacted with the air or provided with a heat dissipation piece 71. And/or a heat conductive metallic material 72 may be provided on the other side of the heat dissipation piece 71. The heat conductive metallic material is copper, aluminum, copper alloy, or alloy comprising copper and aluminum that is easy to conduct heat to enhance the heat dissipation property. The LEDs 15 are very sensitive to the temperature of the working environment. The temperature may affect the chrominance, the output luminous flux, the life span and the working efficiency of the LEDs 15. While the heat dissipation property is enhanced, the luminous quality of the LEDs 15 is stabilized, the chromatic defect of the LEDs 15 is reduced, and the life span of the LEDs 15 is elongated. The light emitting device 1 may be used in wider ranges.

Furthermore, even if one or more LEDs 15 are out of order (such as the LED 15 doesn't emit lights or the brightness of the LEDs 15 decreases), only the misfuntional LEDs need to be replaced. Thus the maintenance fees may be reduced.

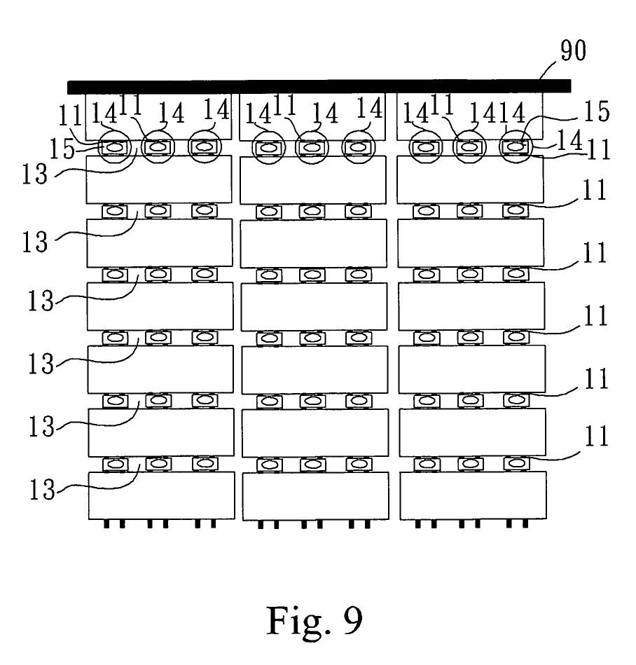

In other aspect of the light emitting device of the present invention, a plurality of the light devices 1 (as shown in FIG. 1) may be connected in any concatenation manner including serial or parallel or any combination thereof or side by side to be used in back light modules having large areas. As shown in FIG. 9, the large light emitting device is obtained by connect 3 light emitting devices 1 (as shown in FIG. 1) side by side on the circuit board 90 of a light emitting module.

Moreover, in other aspect of the light emitting device of the present invention, an adhesive layer (not shown) may be provided on the surface of the coater. The light emitting device 1 may adhere to any material or other products by the adhesive layer.

The above description is the embodiments of the present invention but not to limit the scope of the present invention. The spirit and the scope of the present invention are defined in appended claims.

1. A light emitting device, comprising:
flexible electrical wirings covered with plastic material wherein the plastic material as a coater is placed to coat on the flexible electrical wirings; and
one or more LEDs;
wherein the coater is partially truncated on truncated portions so that one side or both sides of the flexible electrical wiring is/are exposed so as to couple the LEDs with the flexible electrical wirings to supply power for the LEDs.

2. The light emitting device according to claim 1, wherein the coater is flatted after being coated on the flexible electrical wiring, and the shape of the truncated portions is any shape that exposes the flexible electrical wirings to the air, and the portion of the LED that is not in contact with the electrical wiring is exposed to the air.

3. The light emitting device according to claim 1, wherein the coater is selected from a group comprising polyethylene terephthalate, polyester film, polyvinylchloride and polyimide, and the flexible electrical wiring is a copper material.

4. The light emitting device according to claim 1, wherein the number and the pitch of the exposed flexible electrical wiring are varied according to the number and the pins of the corresponding LEDs.

5. The light emitting device according to claim 1, wherein one or more LEDs are provided on the one or both exposed sides of the flexible electrical wirings, or two opposite LEDs are provided on a single area of the exposed flexible electrical wirings.

6. The light emitting device according to claim 1, wherein a circular ferrite core is provided on the surface of the coater, and/or the surface of the coater is covered with conductive silver paste, conductive fabric, acetic fabric, mylar, copper foil or aluminum foil.

7. The light emitting device according to claim 1, wherein the exposed surface of the electrical wiring opposite to the LED is hollow or is provided with a heat dissipation piece, and/or a heat conductive metallic material is provided on the other side of the heat dissipation piece.

8. The light emitting device according to claim 1, wherein the cross-sectional shape of the flexible electrical wirings is a circle, an ellipse, a square, a rectangle or any other shape, the coater is thermo plastic material or thermosetting plastic material, and the electrical wirings are any electrical wiring other than a copper line.

9. The light emitting device according to claim 1, further comprising an adhesive layer provided on the coater so as to adhere the light emitting device on any material or other products.

10. The light emitting device according to claim 1, wherein the LEDs are connected in serial or in parallel or any combination thereof, and/or the flexible electrical wirings are connected in any concatenation manner including serial or parallel or any combination thereof or side by side or any combination thereof.

11. The light emitting device according to claim 1, wherein a plurality of the light emitting devices are connected in any concatenation manner including serial or parallel or any combination thereof or side by side to be used in back light modules having large areas.

12. The light emitting device according to claim 7, wherein the heat conductive metallic material is selected from a group comprising copper, aluminum, copper alloy, aluminum alloy, and alloy comprising copper and aluminum.
